(19) United States
(12) Patent Application Publication
(10) Pub. No.: US 2009/0077085 A1
(43) Pub. Date: Mar. 19, 2009

(54) SUBSTITUTE DATABASE REPLICATION TABLES

(76) Inventors: Ricardo N. Olivieri, Austin, TX (US); Mark B. Whelan, Austin, TX (US)

Correspondence Address: IBM CORP (YA);C/O YEE & ASSOCIATES PC, P.O. BOX 802333, DALLAS, TX, 75380, US

(21) Appl. No.: 11/857,759

(22) Filed: Sep. 19, 2007

(51) Int. Cl. G06F 17/30; G06F 12/16

(52) U.S. Cl. 707/9; 707/204; 707/E17.001; 707/E17.032

(57) ABSTRACT

Illustrative embodiments provide for the creation and maintenance of substitute database replication tables in the form of materialized query tables and associated staging tables for each selected table of a target database. One aspect of an illustrative embodiment provides a method for the creation of substitute database replication tables. The method comprising, obtaining a plurality of input specifications, to create an identified set of target databases of a database management system. The method also establishes a connection with the database management system of the identified set of target databases. Further generating a materialized query table and corresponding staging table combination for each specified table from a plurality of tables belonging to a respective database of the identified set of target databases.

### BACKGROUND OF THE INVENTION

1. Field of the Invention

The present invention relates generally to computer database systems and more specifically to a method, system and computer program product for the creation and maintenance of substitute database replication tables.

2. Description of the Related Art

In many of today's web hosting environments it is typical to find a database replica of the master database used by web application servers. Typically the purpose for having these database replicas is for reporting and querying. For instance, hosting environments usually ensure master database access is only by application servers, for example, web users of the application having read and update rights to the data in the master database. Another set of users, such as batch processes and external computer systems, are given only read access to the same “production” data that also exists in the master database. This other set of users, batch processes and external computer systems has read access to the database replica so they may perform their queries and generate reports without locking any of the tables on the master database.

Data in the database replica may be kept up to date in several ways. One typical way is to use database replication. Replication may incur additional costs, besides the initial replication setup, in the future. For example, there may be need to have a person knowledgeable in updating and managing replication settings whenever changes are made to the parent database structure, such as tables being modified, dropped, and added. Additional administrative charges may then significantly increase the costs of any updates required by the owners of the application. In addition, having a physical database replica means managing an additional database. A database administrator may charge for additional time spent administering database replicas. If database replicas are also kept on separate servers, hosting costs may also be increased due to additional servers.

### SUMMARY OF THE INVENTION

Illustrative embodiments provide for the creation and maintenance of substitute database replication tables in the form of materialized query tables and associated staging tables for each selected table of a target database.

One aspect of an illustrative embodiment provides a method for the creation of substitute database replication tables, the computer implemented method comprising, obtaining a plurality of input specifications, to create an identified set of target databases of a database management system. Further establishing a connection with the database management system of the identified set of target databases and generating a materialized query table and corresponding staging table combination for each specified table from a plurality of tables belonging to a respective database of the identified set of target databases.

Another aspect of an illustrative embodiment provides a data processing system for the creation of substitute database replication tables, the data processing system comprising, a bus, a storage device connected to the bus, a processor connected to the bus and a receiver connected to the bus, capable of obtaining a plurality of input specifications, to create an identified set of target databases of a database management system. Further, a communications connector connected to the bus, capable of establishing a connection with the database management system of the identified set of target databases, and a parser generator connected to the bus, capable of generating a materialized query table and corresponding staging table combination for each specified table from a plurality of tables belonging to a respective database of the identified set of target databases.

Yet another aspect of an illustrative embodiment provides a computer program product for the creation of substitute database replication tables, the computer program product comprising, a computer usable recordable type medium having computer executable instructions tangibly embodied thereon. The computer executable program instructions comprising computer executable program instructions for obtaining a plurality of input specifications, to create an identified set of target databases of a database management system. The computer executable program instructions further comprising computer executable program instructions for establishing a connection with the database management system of the identified set of target databases and computer executable program instructions for generating a materialized query table and corresponding staging table combination for each specified table from a plurality of tables belonging to a respective database of the identified set of target databases.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is pictorial representation of a network of computer systems in accordance with illustrative embodiments;

FIG. 2 is a block diagram of a data processing system in accordance with illustrative embodiments;

FIG. 3 is a block diagram of exemplary data processing system having a database management system in accordance with illustrative embodiments;

FIG. 4 is a block diagram of an exemplary storage device containing a database in accordance with illustrative embodiments;

FIG. 5 is a flowchart of an exemplary table creation process in accordance with illustrative embodiments; and

FIG. 6, a flowchart of the generation process of FIG. 5 in accordance with illustrative embodiments.

### DETAILED DESCRIPTION OF THE PREFERRED EMBODIMENT

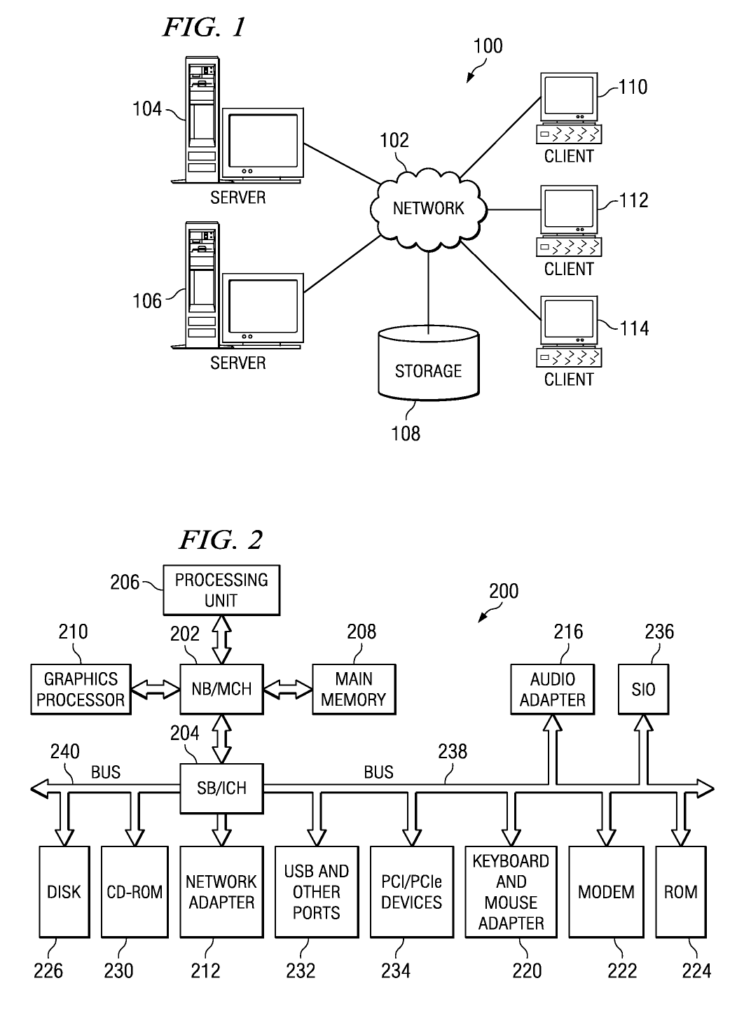

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

As a result of the increasing complexity of data processing systems and with the introduction of multimedia presentations, attempts have been made to simplify the interface between a user and the large amounts of data present within a modern data processing system. One example of an attempt to simplify the interface between a user and a data processing system is the utilization of a so-called graphic user interface (GUI) to provide an intuitive and graphical interface between the user and the data processing system. A GUI is an interface system, including devices, by which a user interacts with a system, system components, and/or system applications via windows or view ports, icons, menus, pointing devices, etc.

Although GUIs have made manipulation of data easier for users in some instances, GUIs have created new problems. For example, a user working in an application frequently selects items from an application menu toolbar. This interaction will require the user to move a pointer via a mouse over a graphical object such as a menu, icon, or control to make a selection.

The term “mouse,” when used in this document, refers to any type of operating system supported graphical pointing device including, but not limited to a mouse, track ball, touch pad, light pin, touch screen, and the like. A pointing device is typically employed by a user of the data processing system to interact with the data processing system's GUI. A “pointer” is an iconic image controlled by a mouse or other such device, and is displayed on the video display device of a data processing system to visually indicate to the user, icons, menus, or other types of graphical objects that may be selected or manipulated.

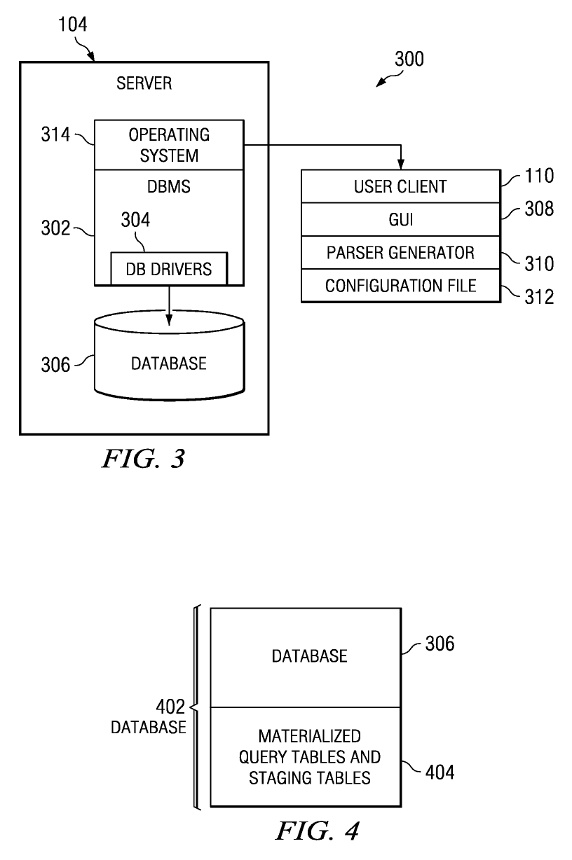

Turning to FIG. 3, a block diagram of a data processing system is shown in which illustrative embodiments may be implemented. Data processing system 300 is an example of a network of computers comprising computers such as server 104 and client 110 in FIG. 1, in which computer usable program code or instructions implementing the exemplary processes may be located for illustrative embodiments.

Client 110 may communicate with the operating system 314 of server 104 containing database management system 302 (DBMS) while additionally providing graphical user interface 308 (GUI), parser generator 310 services, and configuration file 312. Configuration file 312 is a configuration file that may also be implemented in other forms including a property file, simple comma separated values or other form of data input as is known in the art. Although shown on client 110, parser generator 310 and configuration file 312 may be located on another system accessible to client 110 and server 104. Database management system 304 further comprises application programming interfaces(APIs) for database connectivity, database (DB) drivers 304, enabling application programs of client 110 to interact with database management system 302, thereby accessing database 306, contained on a storage device such as disk 226 of FIG. 2.

Graphical user interface 308 and configuration file 312 provide two examples of making input specification available to create an identified set of target databases. Graphical user interface 308 may act as a receiver and may be implemented using a combination of hardware and software including components such as graphics processor 210, and keyboard and mouse adapter 220 of FIG. 2, providing a capability to receive input specifications from a user. Input specifications may be supplied in response to a prompt to the user or by way of a configuration file or combination thereof. A configuration file may also be known as a property file or resource. Input specifications include attribute and value combinations identifying the resource to be processed, how it is to be processed and where the results are to be placed. For example, the user may be prompted to provide the target database name along with authentication information including user ID and password. The target database name specified may be further defined to include filtering of the tables within the target database. Filtering allows a set of tables to be ignored and not have a materialized query table and staging table combination created.

Configuration file 312 may in a similar manner be received from a storage device such as disk 226 across a bus interface such a bus 240 of data processing system 200 in FIG. 2. Application programming interfaces for connectivity, database drivers 304, provide a communications connector capable of establishing a connection with the database management system of the identified set of target databases. Communications connector may be implemented in hardware and software combinations as is known in the art comprising components such as network adapter 212 or modem 222 of FIG. 2.

The use of materialized query tables and staging tables may eliminate the need to have a database replica, while allowing users access to information from the master database. Further, there may be a reduction in the cost compared to database replication requirement for administering a replica database and processing required to copy and move data. Users, such as batch processes and external computer systems, will not query the application tables directly, thereby avoiding the potential to lock the master tables.

In accordance with illustrative embodiments, a materialized query table (MQT) and a staging table, for each materialized query table, for each desired application table in the database are created. Any updates to the application tables are captured in corresponding staging tables. At regular intervals, the captured changes are then propagated to the materialized query tables. Users with direct access to the master database will now have READ access only to these materialized query tables and will not acquire locks on the application tables, allowing the application servers to receive a quicker response whenever a database query or update is performed. Hosting environments typically want to ensure the master database provides a fast response to web application servers.

Illustrative embodiments enable database administrators and other authorized users to create materialized query tables and respective staging tables on the master database with reduced effort by automatically generating all materialized query tables that are needed for the application database tables. The default is to process all tables within the target database, however selective filtering allows a subset of those tables to be processed. Further corresponding users are given READ access to these tables.

With reference now to FIG. 4, a block diagram of disk 226 is shown in which illustrative embodiments may be implemented. Database 402 now shows the combined presence of the previous image of database 306 and materialized query tables and staging tables 404, generated for tables belonging to database 306, creating a new instance. For each selected table of database 306 a materialized query table and associated staging table combination will be created and then stored within the respective database, such as database 306, as in this case. Although not to scale, one skilled in the art would appreciate that the combination of materialized query tables and staging tables 404 and parent database 306, is larger than database 306 was initially. Database 402 has grown with the accommodation of associated materialized query tables and staging tables 404. Although the data may be spread over physical storage devices due to storage limitations, the combination of parent database 306 and materialized query tables and staging tables 404 is one database.

Typical hosting environments enforce applications to set up database replication, thereby creating database replicas to avoid locking issues on the master database. As an alternative to database replication, implementations in accordance with illustrative embodiments may enable avoidance of replication and related intricacies by creating materialized query tables and staging tables on the master database, granting a corresponding READ access to users of these materialized query tables, and scheduling an event to refresh the materialized query tables on a regular basis. Use of materialized query tables and staging tables in this manner differs from using materialized query tables to improve the performance of queries.

Materialized query tables are typically used for improving the performance of complex queries by avoiding the recalculation of values of certain columns repeatedly. Illustrative embodiments automate the creation of materialized query tables and staging tables 404 on a master database for all application tables contained therein and are not specifically query based as previously used. Filter options further allow users to exclude one or more tables from the master database when generating the materialized query tables and staging tables.

The net result is typically a much easier implementation to administer than previously encountered using database replication. Using materialized query tables and staging tables together as an alternative to replication may reduce the hosting costs and maintenance work. Illustrative embodiments automate much of the manual work that otherwise would be required when performing database replication.

In accordance with an illustrative embodiment there are components comprising graphical user interface (GUI) 308, which may be one or more of a command line interface and a graphical user interface, and a parser generator 310 that uses the target database management system API or connectivity driver interface, database drivers 304 to query and update the target database 306 of FIG. 3.

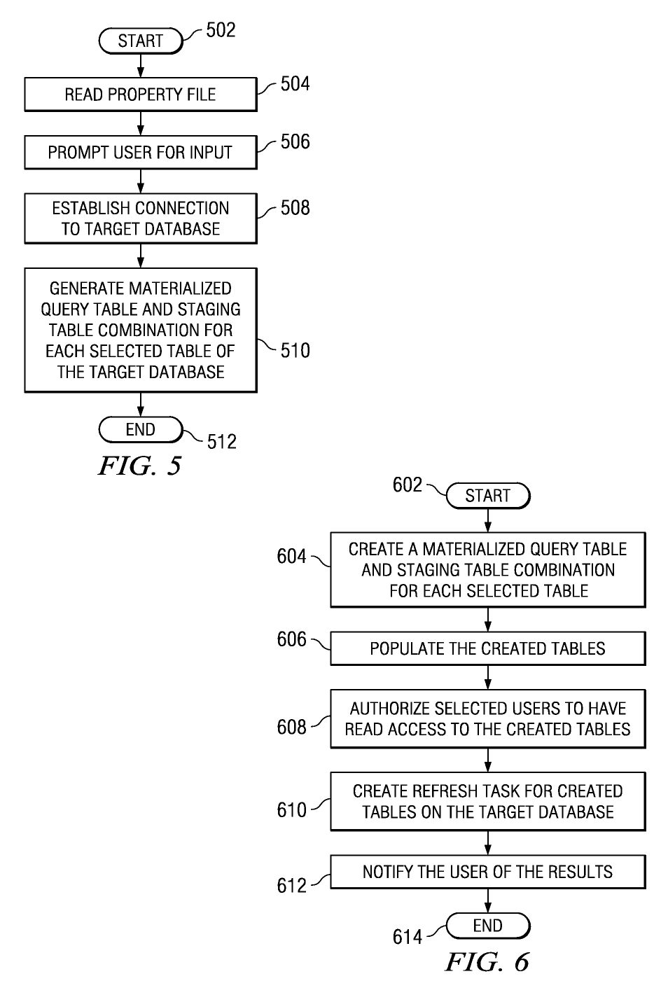

With reference now to FIG. 5, a flowchart of process of parser generator 310 of FIG. 3 is shown in accordance with illustrative embodiments. The process begins with step 502. The property file resource or configuration file 312 provides default settings that are read by parser generator 310 to determine appropriate settings to apply during the process, such as predefined filter values or a naming suffix for generated tables (step 504). Graphical user interface, (GUI) 308 may be used to prompt the user to specify target database 306 connection information comprising user id, password, universal resource locator (URL), port number and other parameters, as may be required and known in the art, to establish connectivity. The user is prompted for this information and enters the data (step 506). Together the combination of property file or configuration file 312 and user interface 308 provide the typical input specifications required for operation of process 500.

Once a connection to database management system of the target database is established (step 508), the user is further prompted to provide the name of the schema or schemas related to target database 306, providing location information to the desired application tables. The user may enter one or more schema names. The user may also specify additional filter parameters if desired, for example, to prescribe materialized query tables and staging tables are not to be created for three of twenty tables that exist in a particular schema. In this case the user is prompted to specify the names of three tables that should be ignored, resulting in the materialized query tables and staging tables for the three tables not being generated, and only materialized query tables and staging tables for seventeen tables being created.

Selective filtering may be implemented in various ways. One typical method may use graphical user interface 308 to prompt the user for the names of the tables to ignore. In an alternate approach, configuration file 312 may be used to state the names of the tables to ignore or another approach to use regular expressions for pattern matching of names of the tables to ignore. Parser generator 310 may then parse configuration file 312 and exclude those tables explicitly named or implicitly named in the file. User interface 308 may also prompt the user to provide user IDs, and group IDs that should be granted READ access to the materialized query tables to be generated.

Having obtained the necessary information from the user, parser generator 310 communicates with target database 306 by means of the target database API and driver interface, database drivers 304 to create the corresponding materialized query tables and staging tables (step 510) with process 500 ending (step 512).

With reference to FIG. 6, a flowchart of the generation process 510 of FIG. 5 in accordance with illustrative embodiments is shown.

For example, in an illustrative embodiment, parser generator 310 may be written in the Java™ language and target database 306 may be DB2®, therefore parser generator 310 implemented in the Java program would use the DB2 Java Database Driver Connectivity (JDBC) application programming interface (API)form of database drivers 304 to establish a connection to the target DB2 database 306 and then issue a series of Structured Query Language (SQL) commands to generate the desired materialized query tables and staging tables 404 of FIG. 4.

A first command in the “conversation” between parser generator 310 and target database management system 302 for target database 306 requests a list of all tables that meet the filtering criteria specified by the user. Tables that do not meet the filtering criteria are, of course, left out of the results. The results returned from this initial query include all column names for each one of the tables that are part of the results. The results may be perceived in one embodiment as a hash table object, wherein the “key” is the table name and the “value” is a list of the columns of the table.

Parser generator 310 then uses each table and column combination. For example, for each entry in the hash table like structure, parser generator 310 issues structured query language statements to loop through a process comprised of dropping any old materialized query tables and staging tables if they exist, creating a corresponding materialized query tables, refreshing the just created materialized query tables to initially populate the materialized query tables, and creating the staging table for the materialized query tables.

Parser generator 310 starts and first deletes any old materialized query tables and staging table that may have been previously created to avoid a problem of creating an object with the same name in the database (step 602). Parser generator 310 issues structured query language statements to create the materialized query tables for the selected tables using the column information of the parent table of the target database (step 604). Once the materialized query table is created, it must be populated with the contents of its respective parent table (step 606). Therefore, parser generator 310 issues structured query language statements to refresh the just created materialized query tables. A structured query language statement is then issued to create the staging table for the materialized query tables. The materialized query tables and staging tables 404, of FIG. 4, are maintained within the now expanded target database 402, thereby eliminating the need to manage additional separate databases.

The naming of the created materialized query tables and staging tables is performed using the name of the parent table and appending a suffix which is configurable. The sequence of characters used as suffixes for the materialized query tables and staging tables may be specified in a properties file, or may be supplied by the user interface. For example, a string “_MQT” could be used as the suffix for all materialized query tables and a string “_MQT_STG” could be used as the suffix for all staging tables. A DB1 table would then have materialized query tables named DB1_MQT and a staging table named DB1_MQT_STG.

Having created a set of related materialized query tables and staging table 404, parser generator 310 further provides means through a sequence of commands to database management system 302 to grant READ access to authorized users of the just completed materialized query tables (step 608).

Once all materialized query tables and staging tables are created, parser generator 310 provides a means to then create an event on the target database to refresh the materialized query tables at regular intervals (step 610). The refresh frequency is a configurable value that may be contained in the property file or configuration file 312 obtained from a user prompt. The scheduled event is a task for refreshing all the materialized query tables that were just created. The name of the scheduled event is also configurable. If an event was previously created by parser generator 310, then that event is removed before creating a new event. It is assumed that target database management system 302 has a scheduling mechanism component.

Having a scheduling mechanism component, such as the task scheduler of DB2, allows parser generator 310 to issue commands over API driver interfaces db drivers 304 of database management system 302 to create the event. However, if the database management system 302 does not have a scheduling mechanism, then other means maybe required. For example, a “cron” job, using the “cron” utility that allows tasks to be automatically run in the background at regular intervals on operating system 314, which is in this example a UNIX™ system, may be used to refresh all materialized query tables. In this case, parser generator 310 could use Secure Shell (SSH), a secure way of transmitting data over TCP/IP networks, to connect to the UNIX based server where the database is located, and then execute commands to create a “cron” job entry that refreshes the materialized query tables. Parser generator 310 is thus able to automate the process of refreshing the materialized query tables using different existing scheduling techniques.

Having created the materialized query tables and staging tables, a list of all the materialized query tables that were successfully generated is provided to the user, and if any errors occurred, the error information is also made available to the user (step 612). Additionally a summary of all the actions that occurred on the behalf of the user such as granting READ access rights to users and groups, and creating the event to refresh materialized query tables at regular intervals is provided. If desired, the output may be directed to a log file for later reference. Process 510 of FIG. 5 then terminates (step 614).

Illustrative embodiments of the process just described provide programmatic control of the generation of materialized query tables and staging tables for respective tables of a selected database. The materialized query tables and staging tables are then used in place of previously created replicated databases. The programmatic control enables more efficient control of the process while the staging tables, in conjunction with scheduled refreshes, provide ongoing incremental update of the materialized query table versions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for the creation of substitute database replication tables, the method comprising:
obtaining a plurality of input specifications, to create an identified set of target databases of a database management system;
establishing a connection with the database management system of the identified set of target databases; and
generating a materialized query table and corresponding staging table combination for each specified table from a plurality of tables belonging to a respective database of the identified set of target databases.

2. The method of claim 1, wherein the generating step further comprises:
selectively filtering the plurality of tables of each respective database of the identified set of target databases.

3. The method of claim 1, wherein the generating step further comprises:
locating the materialized query table and corresponding staging table combination, associated with each specified table of the plurality of tables belonging to the each respective database within the each respective database.

4. The method of claim 1, wherein the generating step further comprises:
authorizing specific users to have READ access to a materialized query table of the materialized query table and corresponding staging table combination.

5. The method of claim 1, wherein the generating step further comprises:
creating a scheduled task to refresh each materialized query table.

6. The method of claim 1, wherein the generating step further comprises:
notifying a user of a generating result by one or both of a user interface and a log file.

7. The method of claim 1 further comprising using the materialized query table and corresponding staging table combination in place of each specified table of the plurality of tables belonging to the each respective database within the each respective database

8. A data processing system for the creation of substitute database replication tables, the data processing system comprising:
a bus;
a storage device connected to the bus;
a processor connected to the bus;
a receiver connected to the bus, capable of obtaining a plurality of input specifications, to create an identified set of target databases of a database management system;
a communications connector connected to the bus, capable of establishing a connection with the database management system of the identified set of target databases; and
a parser generator connected to the bus, capable of generating a materialized query table and corresponding staging table combination for each specified table from a plurality of tables belonging to a respective database of the identified set of target databases.

9. The data processing system of claim 8, wherein the parser generator capability further comprises selectively filtering of the plurality of tables belonging to each respective database of the identified set of target databases.

10. The data processing system of claim 8, wherein the parser generator capability further comprises:
locating the materialized query table and corresponding staging table combinations associated with each specified table of the plurality of tables belonging to the each respective database within the each respective database.

11. The data processing system of claim 8, wherein the parser generator capability further comprises:
authorizing specific users to have READ access to a materialized query table of the materialized query table and corresponding staging table combination.

12. The data processing system of claim 8, wherein the parser generator capability further comprises:
creating a scheduled task to refresh each of the materialized query tables.

13. The data processing system of claim 8, wherein the parser generator capability further comprises:
notifying a user of a generating result by at least one of a user interface and a log file.

14. A computer program product for the creation of substitute database replication tables, the computer program product comprising:
a computer usable recordable type medium having computer executable instructions tangibly embodied thereon, the computer executable program instructions comprising:
computer executable program instructions for obtaining a plurality of input specifications, to create an identified set of target databases of a database management system;
computer executable program instructions for establishing a connection with the database management system of the identified set of target databases; and
computer executable program instructions for generating a materialized query table and corresponding staging table combination for each specified table from a plurality of tables belonging to a respective database of the identified set of target databases.

15. The computer program product of claim 14, wherein the computer executable program instructions for generating further comprises computer executable program instructions for selectively filtering the plurality of tables of each respective database of the identified set of target databases.

16. The computer program product of claim 14, wherein the computer executable program instructions for generating further comprises:
computer executable program instructions for locating the materialized query table and corresponding staging table combinations associated with each specified table of the plurality of tables belonging to the each respective database within the each respective database.

17. The computer program product of claim 14, wherein the computer executable program instructions for generating further comprises:
computer executable program instructions for authorizing specific users to have READ access to a materialized query table of the materialized query table and corresponding staging table combination.

18. The computer program product of claim 14, wherein the computer executable program instructions for generating further comprises:
computer executable program instructions for creating a scheduled task to refresh each of the materialized query tables.

19. The computer program product of claim 14, wherein the computer executable program instructions for generating further comprises:
computer executable program instructions for notifying a user of a generating result by at least one of a user interface and a log file.
